(19) United States
(12) Patent Application Publication
(10) Pub. No.: US 2008/0205754 A1
(43) Pub. Date: Aug. 28, 2008

(54) Color identifying apparatus and color identifying method

(75) Inventors: Toshihiro Ogasawara, Tokyo (JP); Masanori Okayama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/010,842

(22) Filed: Jan. 30, 2008

(30) Foreign Application Priority Data
Jan. 31, 2007 (JP) 2007-020928

(51) Int. Cl. G06K 9/00

(52) U.S. Cl. 382/165

(57) ABSTRACT

A color identifying apparatus for identifying the color of a reaction surface which has caused a color reaction with a gas to be specified includes a storage that, for every set of a plurality of referential color coordinates generated pixel by pixel from RGB bitmap images of a reaction surface which has caused a color reaction with a gas, stores pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface; an image capturing unit that captures an image of the reaction surface and generates RGB bitmap images of the reaction surface; an arithmetic unit that generates a plurality of measured color coordinates pixel by pixel from the RGB bitmap images generated by the image capturing unit, generates measured data, which represents both each coordinate on the chromaticity diagram and frequencies that depend on the numbers of the measured color coordinates corresponding to each one of the coordinates on the chromaticity diagram, specifies one piece of the reference data which corresponds to the measured data by checking the measured data against each piece of the reference data, and specifies the identification information which is related to the identified piece of the reference data; and an output unit that outputs the identification information specified by the arithmetic unit.

This application is based upon and claims the benefit of priority from Japanese patent application No. 2007-20928, filed on Jan. 31, 2007, the disclosure of which is incorporated herein in its entirety by reference.

### BACKGROUND OF THE INVENTION

1. Field of the Invention

The present invention relates to a color identifying apparatus and a color identifying method, and more particularly to a color identifying apparatus and a color identifying method for specifying a gas by identifying the color of a reaction surface which is produced by a color reaction with the gas.

2. Description of the Related Art

There have heretofore been known gas detecting devices for causing a chemical reaction between a gas such as a toxic gas and chemical reagents to change the colors of the chemical reagents. For example, U.S. Pat. No. 6,228,657B1 discloses an M256 chemical agent detection kit.

The gas detecting device includes a plurality of ampules containing respective chemical reagents of different types and a plurality of reaction surfaces such as paper surfaces. When the ampules are crushed, the chemical reagents contained therein flow into the reaction surfaces.

The chemical reagents as they flow onto the reaction surfaces chemically react with a gas that is held in contact with the reaction surfaces. The chemical reaction causes the chemical reagents to change their colors, and the reaction surfaces also change their colors depending on the color changes of the chemical reagents.

The user of the gas detecting device introduces different chemical re-agents into the respective reaction surfaces, and recognizes the concentration of the gas based on the color changes of the reaction surfaces.

U.S. Pat. No. 6,228,657B1 also reveals a reader device for outputting a signal depending on the color of a reaction surface using three photodiodes or a single color CCD sensitive to the colors of R, G, B (red, green, and blue).

A reaction surface may suffer color irregularities during the color reaction. For example, the reaction surface may develop a plurality of areas having different colors.

The reader device disclosed in U.S. Pat. No. 6,228,657B1 does not include any way to deal with such color irregularities on reaction surfaces. Consequently, the disclosed reader device may possibly recognize a color produced by averaging different colors on a reaction surface, i.e., a color that is different from the actual colors on the reaction surface, as the color of the reaction surface.

### SUMMARY OF THE INVENTION

An exemplary object of the invention is to provide a color identifying apparatus and a color identifying method which are capable of highly accurately identifying the color of a reaction surface regardless of color irregularities of the reaction surface during a color reaction.

A color identifying apparatus according to an exemplary aspect of the invention is a color identifying apparatus for identifying a color of a reaction surface which has caused a color reaction with a gas to be specified, the color identifying apparatus includes: a storage that, for every set of a plurality of referential color coordinates generated pixel by pixel from RGB bitmap images of a reaction surface which has caused a color reaction with a gas, stores pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface; an image capturing unit that captures an image of the reaction surface and generates RGB bitmap images of the reaction surface; an arithmetic unit that generates a plurality of measured color coordinates pixel by pixel from the RGB bitmap images generated by the image capturing unit, generates measured data, which represents both each coordinate on the chromaticity diagram and frequencies that depend on the numbers of the measured color coordinates corresponding to each one of the coordinates on the chromaticity diagram, specifies one piece of the reference data which corresponds to the measured data by checking the measured data against each piece of the reference data, and specifies the identification information which is related to the identified piece of the reference data; and an output unit that outputs the identification information specified by the arithmetic unit.

A color identifying method according to an exemplary aspect of the invention is a color identifying method adapted to be carried out by a color identifying apparatus including a storage, for identifying the color of a reaction surface which has caused a color reaction with a gas to be specified, the color identifying method includes: storing, in the storage, for every set of a plurality of referential color coordinates generated pixel by pixel from RGB bitmap images of a reaction surface which has caused a color reaction with a gas, pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface; generating RGB bitmap images of the reaction surface by capturing an image of the reaction surface; generating a plurality of measured color coordinates pixel by pixel from the RGB bitmap images; generating measured data which represents both each coordinate on the chromaticity diagram and frequencies that depend on the numbers of the measured color coordinates corresponding to each one of the coordinates on the chromaticity diagram; specifying one piece of the reference data which corresponds to the measured data by checking the measured data against each piece of the reference data; specifying the identification information which is related to the identified piece of the reference data; and outputting the specified identification information.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a color identifying device according to an exemplary embodiment of the present invention;

FIG. 2 is a perspective view of color sample board 10;

FIG. 3 is a flowchart of an operation sequence of color identifying device 100 according to the exemplary embodiment of the present invention;

FIG. 4 is a diagram showing an example of RGB bitmap data;

FIG. 5 is a diagram showing an example of color coordinate conversion equations;

FIG. 6 is a flowchart showing an example of step 305;

FIG. 7 is a diagram showing color coordinate values;

FIG. 8 is a diagram illustrative of color coordinates (xc, yc) and a chromaticity diagram;

FIG. 9 is a diagram showing reference data and averages (color coordinate values) of Y values;

FIG. 10A is a diagram illustrative of the principles of calculating feature points;

FIG. 10B is a diagram illustrative of the principles of calculating feature points;

FIG. 11 is a diagram showing an example of referential data;

FIG. 12A is a diagram illustrative of the principles of calculating feature points;

FIG. 12B is a diagram illustrative of the principles of calculating feature points;

FIG. 13A is a diagram illustrative of the principles of calculating feature points;

FIG. 13B is a diagram illustrative of the principles of calculating feature points;

FIG. 13C is a diagram illustrative of the principles of calculating feature points;

FIG. 14A is a diagram illustrative of the principles of calculating a center of gravity;

FIG. 14B is a diagram illustrative of the principles of calculating a center of gravity;

FIG. 14C is a diagram illustrative of the principles of calculating a center of gravity;

FIG. 15 is a diagram showing an example of categorized referential data D(1);

FIG. 16 is a diagram showing an example of categorized referential data D(2);

FIG. 17 is a diagram showing an example of categorized referential data D(3);

FIG. 18 is a diagram showing an example of measurement data D(r);

FIG. 19A is a diagram showing an example of checking process results;

FIG. 19B is a diagram showing an example of checking process results; and

FIG. 19C is a diagram showing an example of checking process results.

### DETAILED DESCRIPTION OF EXEMPLARY EMBODIMENT(S)

A color identifying device and a color identifying method according to an exemplary embodiment of the present invention will be described below with reference to the accompanying drawings.

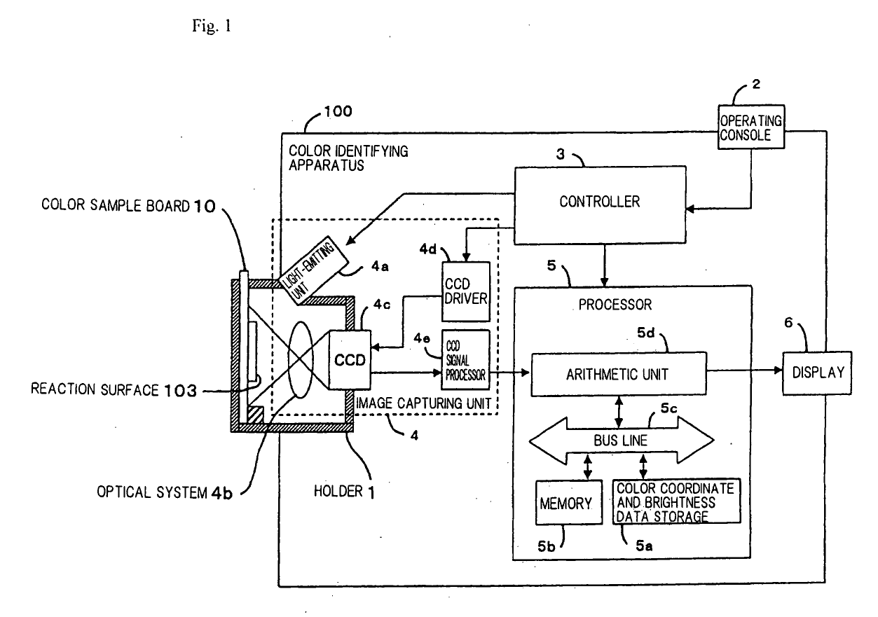

FIG. 1 shows in block form color identifying device 100 according to an exemplary embodiment of the present invention.

As shown in FIG. 1, color identifying device 100 comprises holder 1, operating console 2, controller 3, image capturing unit 4, processor 5, and display 6. Image capturing unit 4 includes light-emitting unit 4a, optical system 4b, CCD 4c, CCD driver 4d, and CCD signal processor 4e. Processor 5 includes color coordinate and brightness data storage (hereinafter referred to as “storage) 5a, memory 5b, bus line 5c and arithmetic unit 5d.

Color sample board 10 is mounted in a predetermined position in holder 1.

Color sample board 10 has reaction surface 103 disposed in a predetermined position thereon.

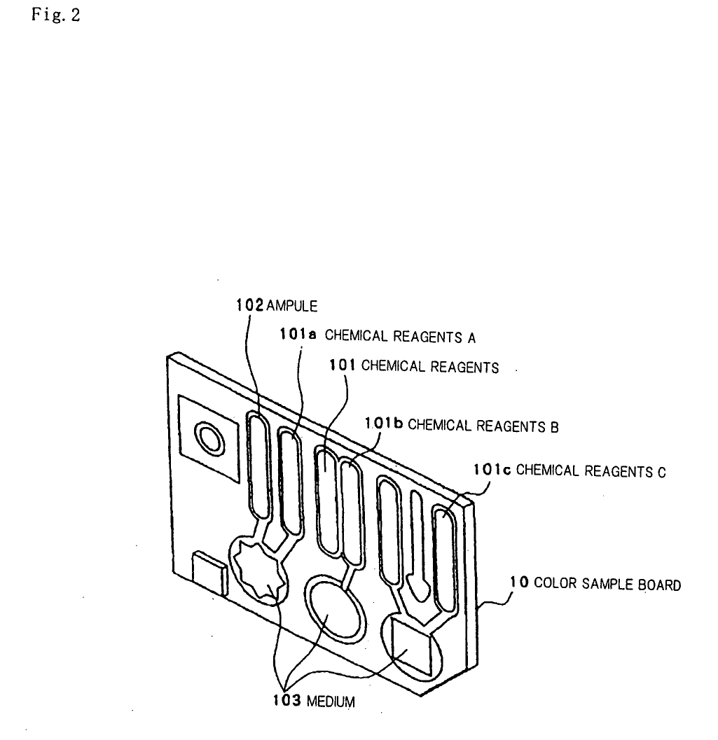

FIG. 2 shows in perspective color sample board 10 by way of example.

As shown in FIG. 2, color sample board 10 has a plurality of chemical reagents 101, a plurality of ampules 102, and a plurality of mediums 103. Ampules 102 contain chemical reagents 101, respectively, which are of different types. Mediums 103 are in the form of respective sheets of paper or the like. When ampules 102 are crushed, chemical reagents contained therein flow into mediums 103. Mediums 103 provide reaction surfaces 103, respectively.

When each chemical reagent 101 flows into medium 103, each chemical reagent 101 causes a color reaction with a gas, e.g., a gas to be identified, which is held in contact with medium 103. The M256 chemical agent detection kit disclosed in U.S. Pat. No. 6,228,657B1, for example, may be used as color sample board 10.

In FIG. 1, color identifying device 100 identifies the gas based on the colors of reaction surface 103 which has caused the color reaction.

Operating console 2 has an operation start button (not shown) which can be operated by the user. When the operation start button is operated, operating console 2 supplies a light emission instruction to controller 3.

In response to the light emission instruction from operating console 2, controller 3 controls operation of image capturing unit 4 and processor 5. Specifically, in response to the light emission instruction from operating console 2, controller 3 controls light-emitting unit 4a to emit light, supplies a drive signal to CCD driver 4d, and operates processor 5.

Image capturing unit 4 can generally be called image capturing means.

In response to an instruction from controller 3, image capturing unit 4 captures an image of reaction surface 103 of color sample board 10 that is mounted in holder 1, and generates RGB bitmap images (hereinafter referred to as “RGB bitmap data”) of reaction surface 103. Of the RGB, R stands for red, G for green, and B for blue.

Light-emitting unit 4a is controlled by controller 3 to apply light to reaction surface 103 of color sample board 10 mounted in holder 1. Light-emitting unit 4a comprises a halogen lamp or an LED, for example. However, light-emitting unit 4a is not limited to a halogen lamp or an LED, but may comprise another light source.

Reaction surface 103 reflects the light emitted from light-emitting unit 4a. When reaction surface 103 causes a color reaction with a gas to be identified, the light reflected by reaction surface 103 represents a color that is generated by the color reaction. During the color reaction, reaction surface 103 may suffer color irregularities, developing a plurality of areas having different colors.

Holder 1 prevents light, which is different from the light emitted from light-emitting unit 4a, from being applied to color sample board 10.

Optical system 4b comprises a lens, for example, and produces an image of reaction surface 103 of color sample board 10 mounted in holder 1 on CCD 4c.

CCD 4c is an example of a color image capturing device. The color image capturing device is not limited to a CCD, but may be any of other image capturing devices, e.g., a CMOS sensor.

In response to the drive signal from controller 3, CCD driver 4d operates CCD 4c to capture a color image of reaction surface 103 which is formed on CCD 4c. CCD 4c supplies an analog color image signal representing the captured color image of reaction surface 103 to CCD signal processor 4e.

CCD signal processor 4e converts the analog color image signal from CCD 4c into digital signal (RGB bitmap data), and supplies the RGB bitmap data to processor 5.

According to the RGB bitmap data, each bit (pixel) is represented by R, G, B signals each having a signal intensity in a range from 0 to 255. The signal intensity range of each of the R, G, B signals is not limited to 0 to 255, but may be another range.

Processor 5 processes the RGB bitmap data from CCD signal processor 4e to identify the color of reaction surface 103, and outputs information depending on the identified color.

Storage 5a can generally be called storage means.

Storage 5a stores, for every set of a plurality of referential color coordinates generated pixel by pixel from the R, G, B signals of RGB bitmap data of a reaction surface which has caused a color reaction with a gas, pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface, in association with each other. The identification information is called as identifying information.

The color coordinates (e.g., referential color coordinates) of the pixels are generated from the R, G, B signals of the pixels based on known color coordinate conversion equations.

Storage 5a also stores a plurality of sets of pieces of reference brightness information generated from the R, G, B signals of RGB bitmap data of a reaction surface which has caused a color reaction with a gas in association with each of the pieces of the reference data and the identifying information.

The reference brightness information is generated from the R, G, B signals of the pixels based on known color coordinate conversion equations.

Memory 5b is used as a working memory of arithmetic unit 5d.

Arithmetic unit 5d can generally be called arithmetic means.

Arithmetic unit 5d operates by executing a program, for example. Arithmetic unit 5d is connected to storage 5a and memory 5b by bus line 5c.

Arithmetic unit 5d generates a plurality of color coordinates (hereinafter referred to as “measured color coordinates”) of the pixels of the RGB bitmap data from the RGB bitmap data generated by image capturing unit 4.

For example, arithmetic unit 5d calculates X, Y, Z, xc and yc from the RGB values of the pixels, for the respective pixels of the RGB bitmap data, using color coordinate conversion equations shown below. The coordinates on a chromaticity diagram which are expressed by calculated xc and yc represent the color coordinates (measured color coordinates) of the pixels, and calculated Y represents brightness information (hereinafter referred to as “measured brightness information”) indicative of the brightness of the pixels.

Color coordinate conversion equations:

X=α1·R+β1·G+γ1·B

Y=α2·R+β2·G+γ2·B

Z=α3·R+β3·G+γ3·B

xc=X/(X+Y+Z)

yc=Y/(X+Y+Z)

where α1, β1, γ1, α2, β2, γ2, α3, β3 and γ3 represent a constant value.

As described above, the color coordinate converting process is of a known nature.

Arithmetic unit 5d generates measured data that represents both each coordinate on the chromaticity diagram and frequencies that depend on the numbers of the measured color coordinates corresponding to each one of the coordinates on the chromaticity diagram.

Arithmetic unit 5d specifies one piece of the reference data corresponding to the measured data by checking the measured data against each piece of the reference data stored in storage 5a, and specifies the identifying information which is related to the specified piece of the reference data.

For example, arithmetic unit 5d specifies one piece of the reference data whose coordinates at a peak value of the frequencies most match those of the measured data. Arithmetic unit 5d specifies the identifying information which is related to the specified piece of the reference data.

Specifically, arithmetic unit 5d calculates products of the frequencies at the same coordinates of the measured data and each piece of the reference data, adds the products, and specifies the identifying information which is related to the piece of the reference data whose sum is the greatest.

If there are a plurality of pieces of reference data corresponding to the measured data, then arithmetic unit 5d specifies one piece of the reference brightness information which corresponds to the measured brightness information by checking each of the piece of the reference brightness information related to the plural pieces of the reference data against the measured brightness information. Arithmetic unit 5d specifies the identifying information which is related to the specified piece of the reference brightness information.

For example, if there are a plurality of pieces of the reference data corresponding to the measured data, then arithmetic unit 5d calculates errors between each of pieces of the reference brightness information related to the plural reference data and the measured brightness information. Arithmetic unit 5d specifies one piece of the reference brightness information, whose error is the smallest, as one piece of the reference brightness information which corresponds to the measured brightness information. Arithmetic unit 5d then specifies the identifying information which is related to the specified piece of the reference brightness information.

Display 6 can generally be called output means.

Display 6 is an example of an output unit and displays the identifying information specified by arithmetic unit 5d. The output unit is not limited to the display, but may be another output unit such as a speech output unit for outputting a speech signal representing the identifying information specified by arithmetic unit 5d.

The reference data and the reference brightness information stored in storage 5a should preferably be measured data and measured brightness information which are generated by arithmetic unit 5d based on RGB bitmap images generated when image capturing unit 4 captures images of reaction surfaces which caused color reactions with gases.

However, the reference data and the reference brightness information stored in storage 5a are not limited to the measured data and the measured brightness information which are generated by arithmetic unit 5d.

Operation of color identifying device 100 according to the present exemplary embodiment will be described below.

Color identifying device 100 stores the pieces of the reference data, the pieces of the reference brightness information and the pieces of identifying information in storage 5a. Thereafter, color identifying device 100 identifies the color of reaction surface 103 based on RGB bitmap data of reaction surface 103, which are generated by image capturing unit 4, the reference data and the reference brightness information stored in storage 5a, and outputs information representing the identified color.

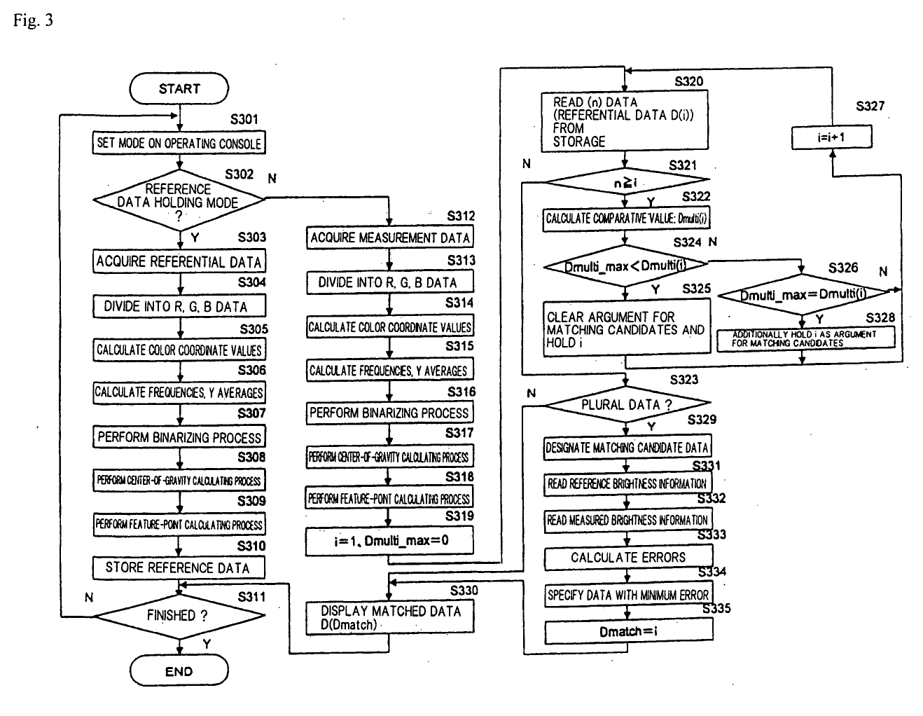

FIG. 3 is a flowchart of an operation sequence of color identifying device 100.

An operation sequence of color identifying device 100 for storing data in storage 5a will be described below.

The user inserts color sample board 10 having reaction surface 103, which has caused a color reaction with a specified gas, into a given position in holder 1.

The user then operates a reference data holding button (not shown) on operating console 2, placing color identifying device 100 into a reference data holding mode in step 301.

When the user operates an operation start button (not shown) on operating console 2 under the reference data holding mode in step 302, operating console 2 supplies a light emission instruction to controller 3.

In response to the light emission instruction from operating console 2, controller 3 controls light-emitting unit 4a to emit light, supplies a drive signal to CCD driver 4d, and operates processor 5.

Reaction surface 103 reflects the light emitted from light-emitting unit 4a, and optical system 4b focuses an image of reaction surface 103 onto CCD 4c. Based on a drive signal from controller 3, CCD driver 4d energizes CCD 4c to capture the image of reaction surface 103 on CCD 4c.

CCD 4c supplies an analog color image signal representing the captured image of reaction surface 103 to CCD signal processor 4e. CCD signal processor 4e converts the analog color image signal into RGB bitmap data, and supplies the RGB bitmap data to arithmetic unit 5d.

Arithmetic unit 5d acquires the RGB bitmap data (referential data) in step 303.

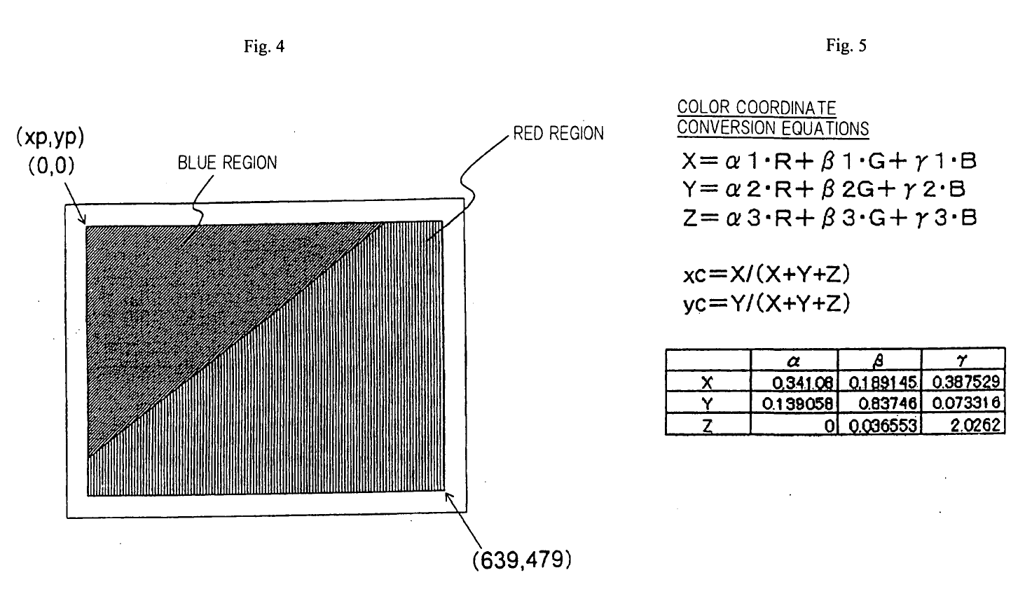

FIG. 4 is a diagram showing an example of RGB bitmap data which are acquired by arithmetic unit 5d when CCD 4c having 640 horizontal pixels×480 vertical pixels captures an image of reaction surface 103 having blue and red regions. In FIG. 4, the position of each of the pixels is represented by horizontal and vertical coordinates (xp, yp).

Then, arithmetic unit 5d divides the RGB bitmap data into signal intensity data in respective R, G, B regions, and sends the signal intensity data in the respective R, G, B regions through bus line 5c to memory 5b where the signal intensity data in the respective R, G, B regions are stored in step 304.

Then, arithmetic unit 5d reads the R, G, B signal intensity data of the respective pixels from memory 5b, and converts the R, G, B signal intensity data into reference color coordinate values X, Y, Z, xc and yc using the color coordinate conversion equations in step 305.

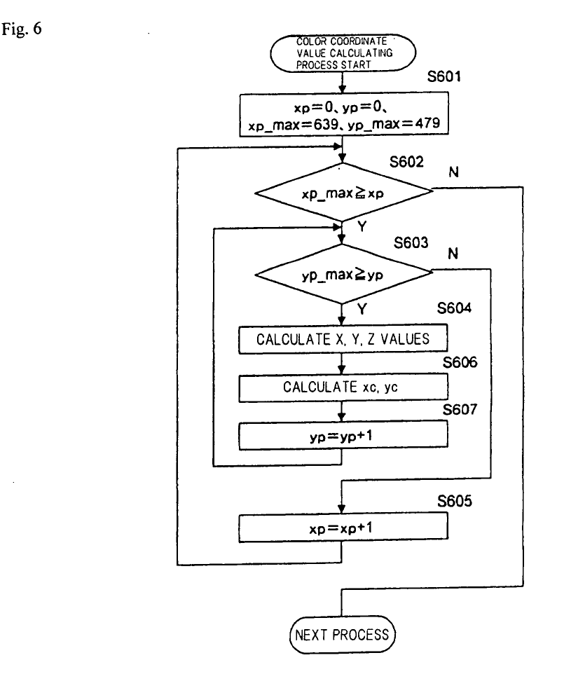

FIG. 5 shows an example of the color coordinate conversion equations used in step 305.

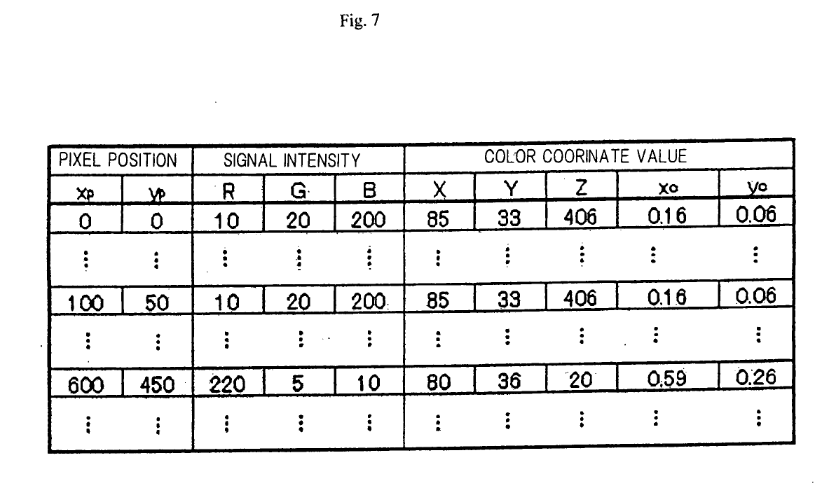

FIG. 6 is a flowchart showing an example of step 305. Details of step 305 will be described below with reference to FIG. 6. The flowchart shown in FIG. 6 is used to process the RGB bitmap data having 640 horizontal pixels×480 vertical pixels.

Arithmetic unit 5d sets xp=0, yp=0, xp_max=639 and yp_max=479 in step 601.

Then, arithmetic unit 5d determines whether xp_max≧xp is satisfied or not in step 602. If xp_max≧xp is satisfied, then control goes to step 603. If xp_max≧xp is not satisfied, then the operation sequence of step 305 is put to an end.

In step 603, arithmetic unit 5d determines whether yp_max≧yp is satisfied or not. If yp_max≧yp is satisfied, then control goes to step 604. If yp_max≧yp is not satisfied, then control goes to step 605.

In step 604, arithmetic unit 5d reads the R, G, B signal intensity data of a pixel at coordinates (xp, yp) from memory 5b. Then, arithmetic unit 5d calculates X, Y and Z from the R, G, B signal intensity data of each pixel according to the color coordinate conversion equations (X=α1·R+β1·G+γ1·B, Y=α2·R+β2·G+γ2·B, Z=α3·R+β3·G+γ3·B) shown in FIG. 5.

Then, arithmetic unit 5d calculates color coordinates (xc, yc) from X, Y and Z calculated in step S604 according to the color coordinate conversion equations (xc=X/(X+Y+Z), yc=Y/(X+Y+Z)) shown in FIG. 5 in step 606.

Then, arithmetic unit 5d calculates yp=yp+1 in step 607. Then, control goes back to step 603.

In step S605, arithmetic unit 5d calculates xp=xp+1. Then, control goes back to step 602.

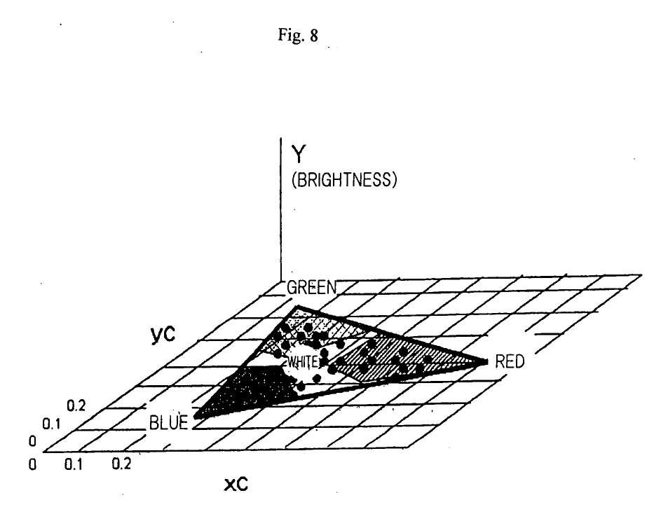

FIG. 7 is a diagram showing color coordinate values which are generated when arithmetic unit 5d has processed the R, G, B signal intensity data in step 305.

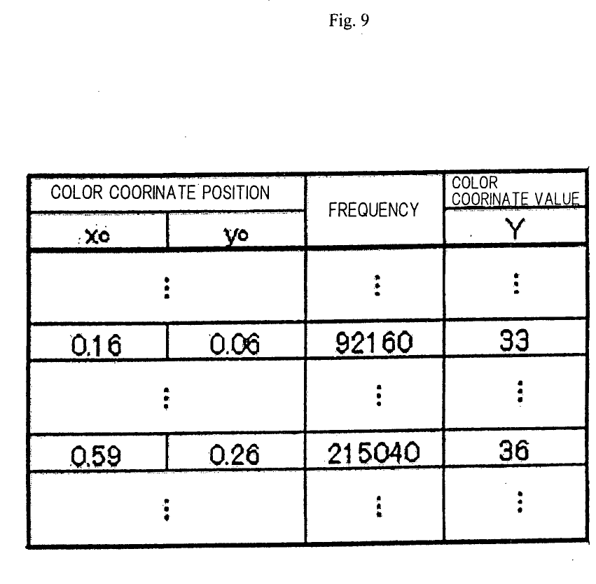

FIG. 8 is a diagram illustrative of color coordinates (xc, yc) and a chromaticity diagram. Color coordinates (xc, yc) and the chromaticity diagram will be described below with reference to FIG. 8.

Color coordinates (xc, yc) calculated in step 305 are included in a triangle (chromaticity diagram) represented on a plane defined by an xc axis and a yc axis and having vertexes indicative of blue, red and green. Coordinates of the center of the triangle represent white. Coordinates that are closer to the vertexes mean that the colors represented by those coordinates are closer to the colors at the vertexes.

If the RGB bitmap data acquired by arithmetic unit 5d represent a full monochrome, then all color coordinates (xc, yc) calculated by arithmetic unit 5d indicate a single spot (single coordinate pair) in the chromaticity diagram.

When color coordinates (xc, yc) calculated by arithmetic unit 5d from RGB bitmap data representative of a color irregularity are plotted on the chromaticity diagram, plotted color coordinates (xc, yc) represent some peaks (whose heights are indicated by Y values in FIG. 8) scattered at plurality positions on the chromaticity diagram.

Usually, an obtained color is expressed by numerical values as color coordinates (xc, yc) on the chromaticity diagram.

According to the present exemplary embodiment, arithmetic unit 5d models color coordinates (xc, yc) scattered in the region of the chromaticity diagram as feature points. Arithmetic unit 5d determines the color of reaction surface 103 based on the distribution of feature points on the chromaticity diagram.

Y values along a Z-axis perpendicular to the plane defined by the xc axis and the yc axis represent brightness values. Arithmetic unit 5d determines the color of reaction surface 103 and the concentration of the gas which has caused the color reaction with reaction surface 103, using three data value, i.e., xc, yc, and Y.

In FIG. 3, arithmetic unit 5d counts color coordinates corresponding to each one of coordinates (xc, yc) on the chromaticity diagram. Arithmetic unit 5d generates a piece of the reference data, which represents both the coordinates on the chromaticity diagrams and the frequencies that depend on the numbers of color coordinates corresponding to each one of the coordinates on the chromaticity diagrams, and then calculates averages of the Y values for the respective coordinates in step 306.

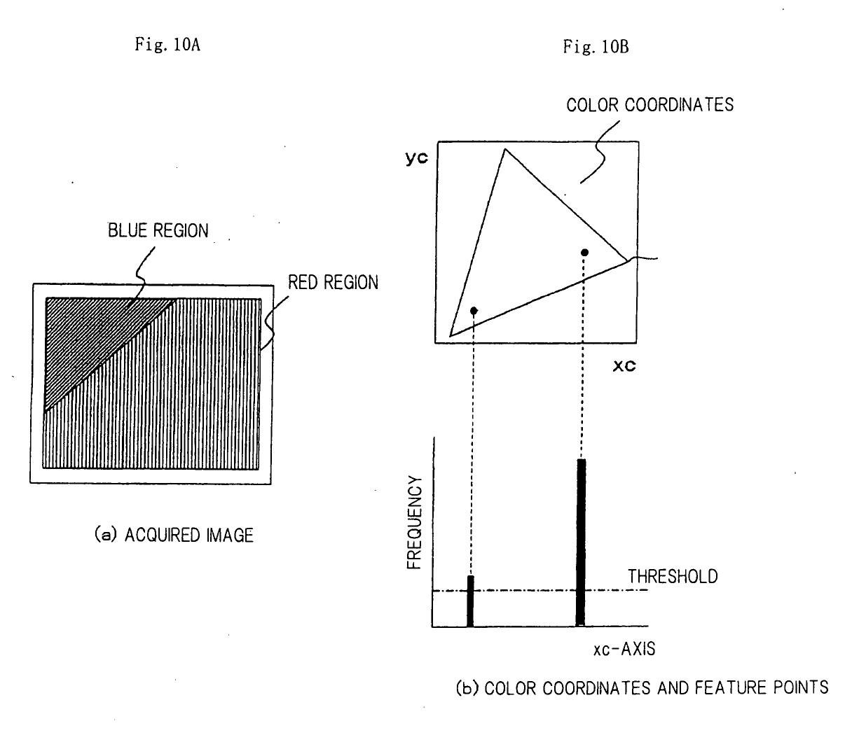

FIG. 9 is a diagram showing a piece of the reference data and averages (color coordinate values) of Y values which are generated and calculated when arithmetic unit 5d has processed the R, G, B signal intensity data shown in FIG. 4 in step 306.

According to the piece of the reference data shown in FIG. 9, since the RGB bitmap data shown in FIG. 4 represent two monochromes, i.e., blue and red, the frequencies are “0” for those areas (coordinates) other than color coordinates (xc, yc)=(0.16, 0.06) that correspond to blue and color coordinates (xc, yc)=(0.59, 0.26) that correspond to red.

Then, arithmetic unit 5d performs a binarizing process in step 307, a center-of-gravity calculating process in step 308, and a feature-point calculating process in step 309 to determine coordinates with high frequencies in the piece of the reference data as feature points.

The principles of calculating feature points will be described below.

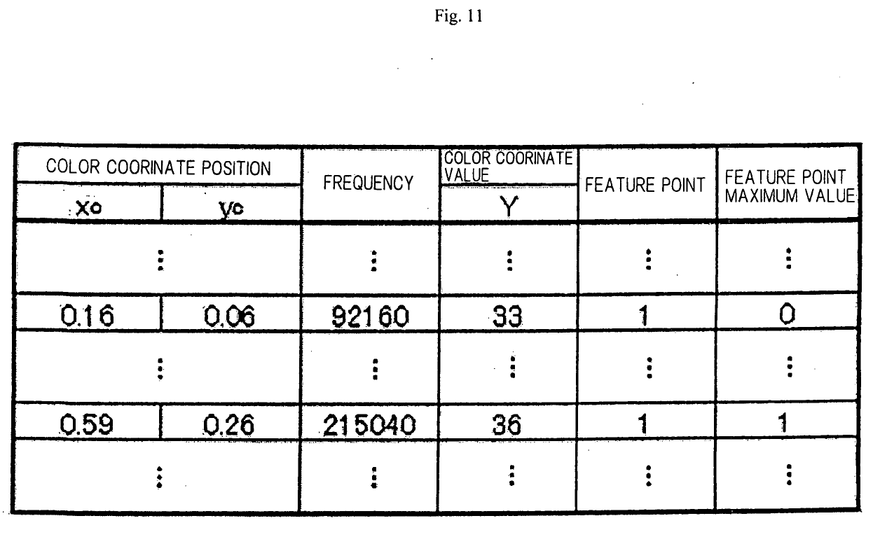

FIGS. 10A and 10B are diagrams illustrative of the principles of calculating feature points.

An acquired image of two colors, blue and red, shown in FIG. 10A is represented by two points on a chromaticity diagram shown in FIG. 10B (all pixels are represented by the two points since the colors are monochromatic), and the frequencies of the coordinates of the two points are proportional to the areas of the blue and red regions.

Arithmetic unit 5d recognizes coordinates corresponding to frequencies in excess of a certain threshold (blue coordinates [(0.16, 0.06)] and red coordinates [(0.59, 0.26)] in FIG. 10B) as feature points. Arithmetic unit 5d adds feature point information “1” to those coordinates, and adds feature point information “0” to the other coordinates.

Arithmetic unit 5d then recognizes the coordinates corresponding to the maximum frequency in the piece of the reference data as a feature point maximum value. Arithmetic unit 5d adds feature point maximum value information “1” to the coordinates and adds feature point maximum value information “0” to the other coordinates.

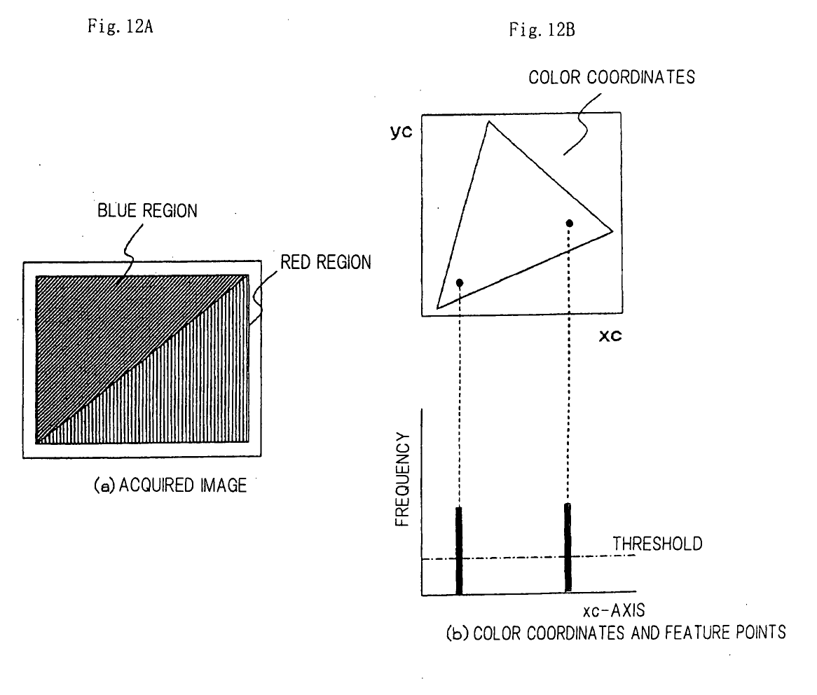

FIG. 11 is a diagram showing an example of a piece of the reference data to which color coordinate values Y, feature point information, and feature point maximum value information are added. The reference data to which color coordinate values Y, feature point information, and feature point maximum value information are added will be referred to as “referential data”).

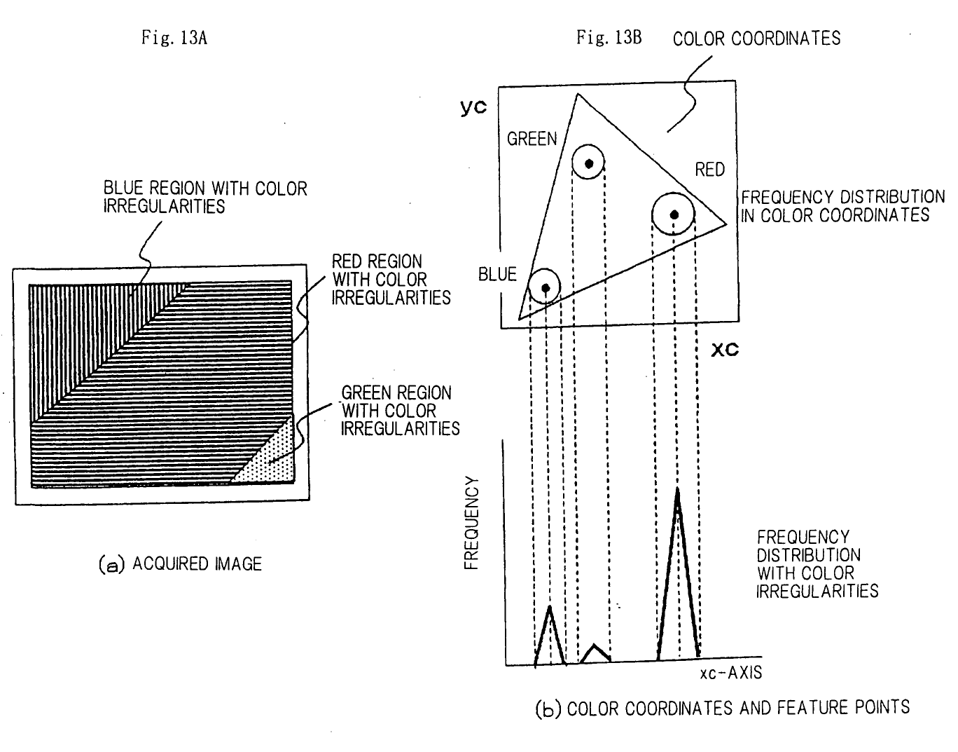

FIGS. 12A and 12B are diagrams showing an acquired image having a blue region and a red region, each occupying 50% of the entire image, and color coordinates and feature points depending on those acquired images. In FIGS. 12A and 12B, since each of the blue and red regions occupies 50% of the entire image, the frequency corresponding to blue coordinates and the frequency corresponding to red coordinates are identical to each other.

A comparison of FIG. 11 and FIGS. 12A, 12B indicates that though the ratio of the areas of the blue and red regions shown in FIG. 11 and the ratio of the areas of the blue and red regions shown in FIGS. 12A, 12B are different from each other, the color coordinates shown in FIG. 11 and FIGS. 12A, 12B are the same as each other on the chromaticity diagram.

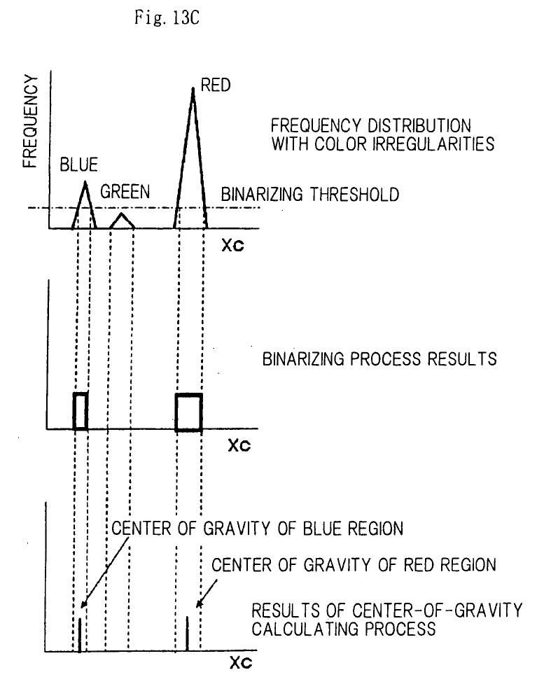

FIGS. 13A through 13C are diagrams showing an example in which colors (blue, red, and green) indicated by an acquired color have color irregularities (not monochromatic).

As shown in FIGS. 13A and 13B, since the colors (blue, red, and green) have color irregularities, the color coordinates on the chromaticity diagram are not represented by single blue, red, and green points, but are scattered. The color coordinates are scattered according to a Gaussian distribution (upwardly convex distribution) having a maximum value represented by the frequency of a color that is a main component.

Arithmetic unit 5d binarizes the frequencies using a certain threshold in step 307. As a result, as shown in FIG. 13C, the frequencies of blue and red which are in excess of the threshold remain unremoved, but the frequency of green which is smaller than the threshold is removed.

Then, arithmetic unit 5d performs the center-of-gravity calculating process in step 308.

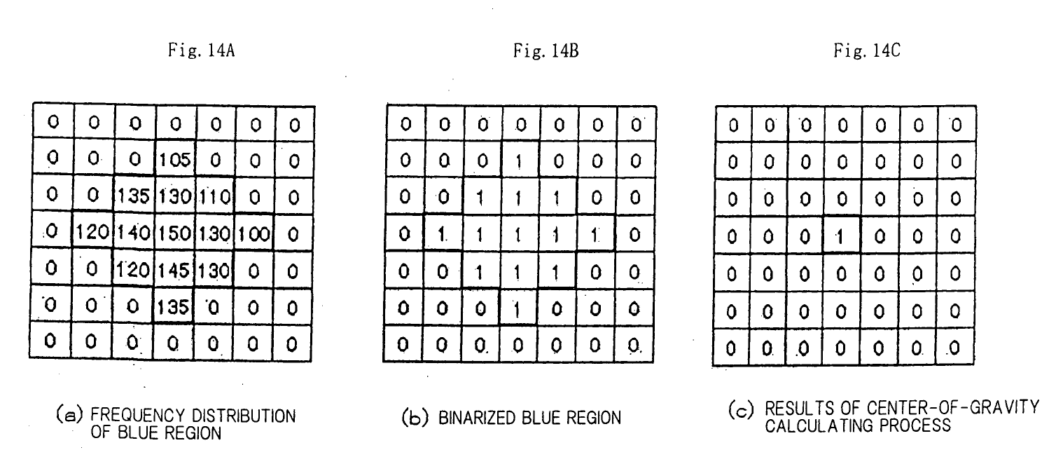

FIGS. 14A through 14C are diagrams illustrative of the principles of calculating a center of gravity.

FIG. 14A shows a frequency distribution of the blue region. In step 307, arithmetic unit 5d binarizes the frequencies of the blue region using a threshold of 80. FIG. 14B shows a binarized frequency distribution of the blue region. Arithmetic unit 5d calculates the center of gravity of the binarized frequency distribution of the blue region.

Arithmetic unit 5d determines the coordinates corresponding to the calculated center of gravity as a feature point, adds feature point information “1” to the coordinates determined as the feature point, and adds feature point information “0” to the other coordinates (see FIG. 14C). Arithmetic unit 5d determines coordinates that correspond to the maximum frequency in the center-of-gravity reference data as a feature point maximum value. Arithmetic unit 5d adds feature point maximum value information “1” to the coordinates and adds feature point maximum value information “0” to the other coordinates in step 309.

Feature point information is obtained when frequencies are binarized. Therefore, feature point information represents frequencies.

Then, arithmetic unit 5d displays a message for prompting the user to enter a category such as a referential data name or the like, on display 6. When the user operates operating console 2 based on the message to enter a category, operating console 2 supplies the entered category to controller 3, which supplies the category to arithmetic unit 5d.

The category will be used as a data name when finally identified data are displayed on display 6.

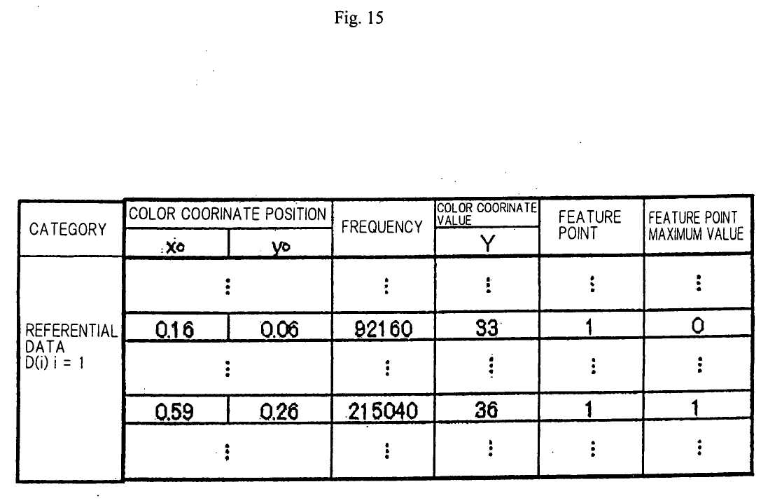

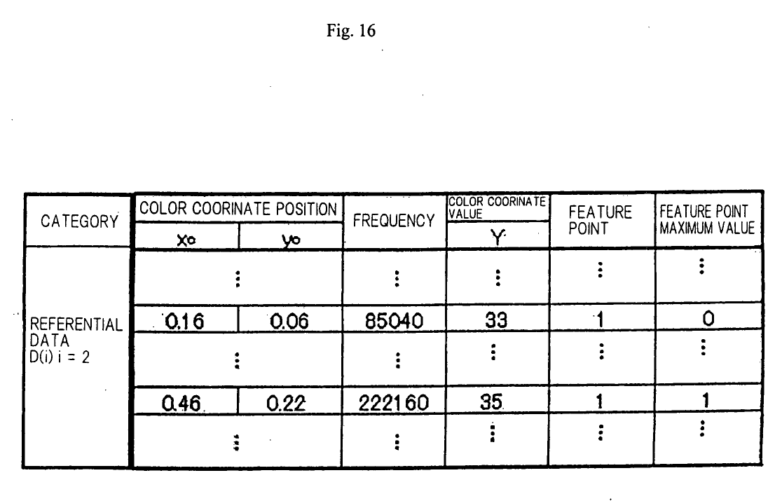

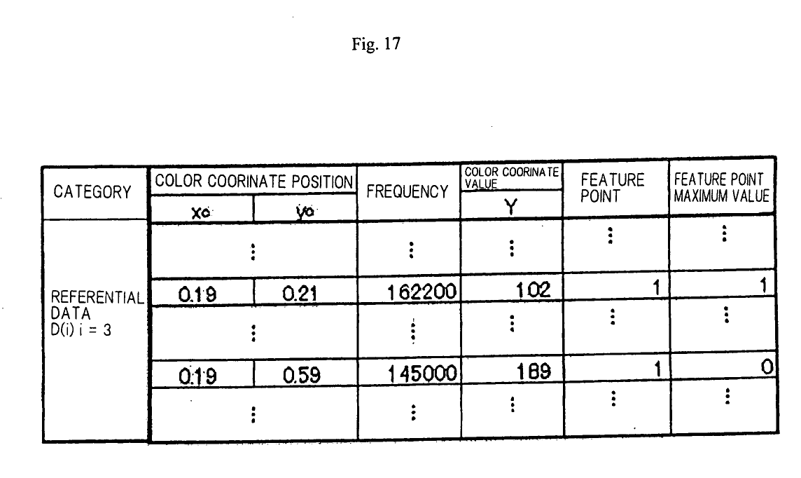

When arithmetic unit 5d receives the category, arithmetic unit 5d associates the category with the referential data, and stores all the data as a lump, i.e., categorized referential data, in storage 5a through bus line 5c in step 310. The categorized referential data stored in storage 5a have structures as shown in FIGS. 15 through 17, for example.

Thereafter, the above process is repeated as the user changes color sample board 10 in holder 1 to successive color sample boards 10 whose reaction surfaces 103 have chemically reacted with gases of different gas components in step 311.

Then, arithmetic unit 5d identifies the color of reaction surface 103 based on the RGB bitmap data of reaction surface 103 which are generated by image capturing unit 4 and the reference color information stored in storage 5a, and outputs information representing the identified color. Such a process of arithmetic unit 5d will be described below with reference to FIG. 3.

The user inserts color sample board 10 having reaction surface 103 which has caused a color reaction with a gas to be specified into a given position in holder 1.

The user then operates the reference data holding button (not shown) on operating console 2, canceling the reference data holding mode in step 301.

When the user operates the operation start button on operating console 2 with the reference data holding mode being canceled in step 302, light-emitting unit 4a emits light, and CCD 4c captures an image of reaction surface 103 and supplies an analog color image signal representing the captured image of reaction surface 103 to CCD signal processor 4e. CCD signal processor 4e converts the analog color image signal into RGB bitmap data, and supplies the RGB bitmap data to arithmetic unit 5d.

Arithmetic unit 5d acquires the RGB bitmap data (measurement data) in step 312.

Thereafter, arithmetic unit 5d executes steps 313 through 318. Step 313 is identical to step 304, step 314 to step 305, step 315 to step 306, step 316 to step 307, step 317 to step 308, and step 318 to step 309.

In steps 313 through 318, “reference data” referred to in steps 304 through 309 are referred to as “measured data”, and “referential data D(i)” as “measurement data D(r)”.

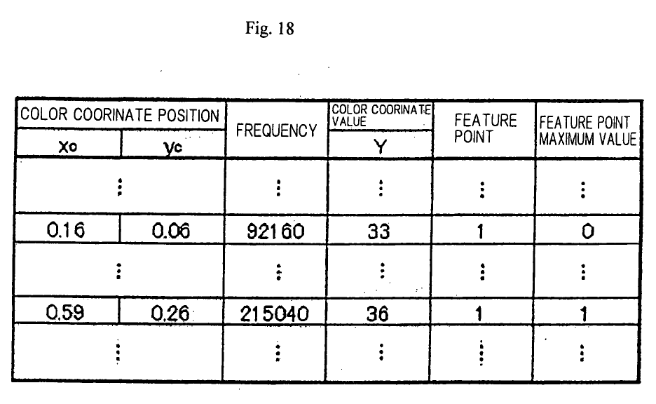

FIG. 18 is a diagram showing an example of measurement data D(r).

Then, arithmetic unit 5d sets i=1, Dmulti_max=0 in step 319.

Then, arithmetic unit 5d reads the piece of the referential data D(i) from memory 5a, and stores the piece of the referential data D(i) in memory 5b through bus line 5c in step 320.

Then, arithmetic unit 5d determines whether n≧i is satisfied or not in step 321. N represents the number of items of referential data.

If n≧i is satisfied, then control goes to step 322. if n≧i is not satisfied, then control goes to step 323.

In step 322, arithmetic unit 5d refers to memory 5b, calculates products of feature point information (frequencies) at the same coordinates of the piece of the referential data D(i) and measurement data D(r), and adds the products, producing sum value Dmulti(i).

Then, arithmetic unit 5d determines whether Dmulti_max<Dmulti(i) is satisfied or not in step 324.

If Dmulti_max<Dmulti(i) is satisfied, then control goes to step 325. If Dmulti_max<Dmulti(i) is not satisfied, then control goes to step 326.

In step 325, arithmetic unit 5d sets Dmulti_max=Dmulti(i) and Dmatch=i, clears a value held as an argument for matching candidates, and holds i as an argument for matching candidates. Thereafter control goes to step 327.

In step 327, arithmetic unit 5d sets i=i+1. Thereafter, control goes to step 320.

In step 326, arithmetic unit 5d determines whether Dmulti_max=Dmulti(i) is satisfied or not.

If Dmulti_max=Dmulti(i) is satisfied, then control goes to step 328. If Dmulti_max=Dmulti(i) is not satisfied, then control goes to step 327.

In step 328, arithmetic unit 5d additionally holds i as an argument for matching candidates. Then, control goes to step 327.

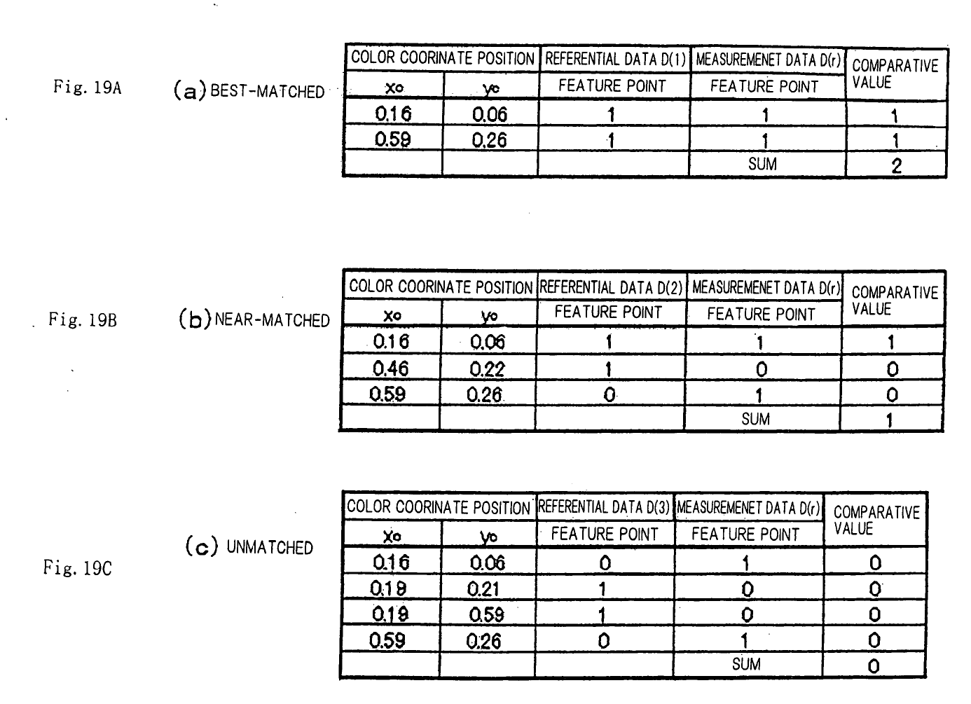

FIGS. 19A through 19C are diagrams showing examples of checking process results produced when the pieces of the reference data in referential data D(1) through D(3) and the measured data in measurement data D(r) are checked against each other. Each piece of data has feature point information “1” only at two coordinate positions.

Referential data D(1) and measurement data D(r) have feature point information “1” overlapping each other at coordinates (xc, yc)=(0.16, 0.06) and coordinates (xc, yc)=(0.59, 0.26). Therefore, product value “1” of feature point information “1” at coordinates (0.16, 0.06) and product value “1” of feature point information “1” at coordinates (0.59, 0.26) are added to each other, producing comparative value (Dmulti(1))=2.

Referential data D(2) and measurement data D(r) are compared with each other at three coordinate positions. They have feature point information “1” overlapping each other at one coordinate position, and not overlapping each other at the other two coordinate positions. Therefore, comparative value (Dmulti(2))=1 is produced.

Referential data D(3) and measurement data D(r) are compared with each other at four coordinate positions. There are no coordinate positions with feature point information “1” overlapping each other. Therefore, comparative value (Dmulti(3))=0 is produced.

After comparative values are calculated with respect to all the referential data, the referential data with the greatest comparative data become color data which most match the measurement data.

A plurality of referential data may possibly take a maximum comparative value.

In step 323, therefore, arithmetic unit 5d refers to the value held as an argument for candidates for match, and determines whether a plurality of pieces of the referential data take a maximum comparative value or not.

Specifically, if a plurality of values are held as an argument for candidates for match, then arithmetic unit 5d judges that a plurality of the referential data take a maximum comparative value. If only one value is held as an argument for candidates for match, then arithmetic unit 5d judges that a plurality of the pieces of the referential data do not take a maximum comparative value.

If a plurality of the referential data take a maximum comparative value, then control goes to step 329. if a plurality of the pieces of the referential data do not take a maximum comparative value, then control goes to step 330.

In step 329, arithmetic unit 5d specifies the plural referential data which have taken the maximum comparative value based on the values (i) held as an argument for candidates for match, and designates the plural referential data as candidate data for match.

Then, arithmetic unit 5d reads color coordinate values Y (reference brightness information) that correspond to feature point maximum value information “1” for the respective candidate data for match in step 331.

Then, arithmetic unit 5d reads color coordinate values Y (measured brightness information) that correspond to feature point maximum value information “1” from measurement data D(r) in step 332.

Then, arithmetic unit 5d calculates errors between each of the pieces of the reference brightness information and the measured brightness information (e.g., absolute values of the difference between each of the pieces of the reference brightness information and measured brightness information) for the respective candidate data for match in step 333.

Then, arithmetic unit 5d specifies a minimum piece of the calculated errors, and specifies candidate data for match corresponding to the specified error in step 334.

Then, arithmetic unit 5d registers the value of i of the matching candidate data in Dmatch, thereby updating Dmatch in step 335. Thereafter, control goes back to step 330.

In step 330, arithmetic unit 5d displays the category corresponding to i indicated by Dmatch as data corresponding to reaction surface 103 in holder 1.

According to the present exemplary embodiment, arithmetic unit 5d specifies one piece of the reference data which corresponds to the measured data by checking the measured data generated from the RGB bitmap data from image capturing unit 4 against the each piece of the reference data, and specifies a category that is related to the specified piece of the reference data.

Each piece of data represents both each coordinate position on the chromaticity diagram and frequencies that depend on the number of color coordinates corresponding to each one of the coordinate positions on the chromaticity diagram. The color coordinates are generated from the RGB bitmap data of the reaction surface for each of the pixels. Individual colors of the reaction surface are represented by the color coordinates of the pixels. Therefore, the data, which represents both the coordinate positions on the chromaticity diagram and frequencies that depend on the numbers of color coordinates corresponding to each one of the coordinate positions on the chromaticity diagram, individually represent the features of different colors on the reaction surface.

Therefore, even if the reaction surface suffers color irregularities, the above data are capable of indicating the features of the individual colors on the reaction surface.

Consequently, even if the reaction surface suffers color irregularities during the color reaction, the color of reaction surface can be identified with high accuracy by checking the data used to identify the color of the reaction surface.

According to the present exemplary embodiment, arithmetic unit 5d specifies one piece of the reference data whose coordinates at a peak value of the frequencies most match those of the measured data, and specifies the category which is related to the specified piece of the reference data.

If the colors developed on the reaction surface remain the same, the coordinates at frequency peaks do not vary even when the areas of the colors change. According to the present exemplary embodiment, therefore, even if the area ratios of the colors that are developed on the reaction surface during the color reaction vary, the color of the reaction surface can be identified with high accuracy without being adversely affected by the variations of the area ratios of the colors.

According to the present exemplary embodiment, arithmetic unit 5d calculates the products of the frequencies at the same coordinates of the measured data and each piece of the reference data, adds the products, and specifies a category which is related to the piece of the reference data whose sum of the products is the greatest.

In this case, it is possible to specify, by way of calculation, one piece of the reference data whose coordinates at a peak value of the frequencies most match those of the measured data.

According to the present exemplary embodiment, furthermore, if there are a plurality of pieces of reference data corresponding to measured data, then arithmetic unit 5d specifies one piece of the reference brightness information which corresponds to the measured brightness information by checking each of the pieces of the reference brightness information related to the plurality of pieces of the reference data against the measured brightness information, and specifies a category which is related to the specified piece of the reference brightness information.

Brightness information generated from RGB bitmap images of the reaction surface varies depending on the concentration of the gas which has caused a color reaction with the reaction surface. Therefore, the color of the reaction surface can be identified highly accurately based on the concentration of the gas.

According to the present exemplary embodiment, furthermore, if there are a plurality of pieces of reference data corresponding to measured data, then arithmetic unit 5d calculates errors between the measured brightness information and each of the pieces of the reference brightness information related to the plural pieces of the reference data, specifies one piece of the reference brightness information, whose error is the smallest, as one piece of the reference brightness information corresponding to the measured brightness information, and specifies a category which is related to the specified piece of the reference brightness information.

Accordingly, the piece of the reference brightness information corresponding to the measured brightness information can be specified by way of calculation.

According to the present exemplary embodiment, furthermore, storage 5a stores, as reference data and reference brightness information, measured data and measured brightness information that are generated by arithmetic unit 5d from RGB bitmap images that are captured in advance by image capturing unit 5 of reaction surfaces 103 which have caused color reactions with gases.

The reference data and the reference brightness information represent information that depends on the characteristics of image capturing unit 4, making it easy to match the reference data and the reference brightness information, and the image capturing characteristics of image capturing unit 4.

A category stored in storage 5a may comprise gas identifying information (e.g., gas names) for identifying a reaction surface by a gas which has chemically reacted with the reaction surface.

It is thus possible to output identifying information for identifying a gas which has chemically reacted with reaction surface 103. Therefore, it is easy to specify the gas which has chemically reacted with the reaction surface.

According to the present exemplary embodiment, furthermore, the color of the reaction surface is identified using data which represents both each coordinate position on the chromaticity diagram and frequencies that depend on the number of color coordinates corresponding to each one of the coordinate position on the chromaticity diagram. The color coordinates are generated from the RGB bitmap data of the reaction surface for each of the pixels. Individual colors of the reaction surface are represented by the color coordinates of the pixels. Therefore, the data, which represents both the coordinate positions on the chromaticity diagram and the frequencies that depend on the numbers of color coordinates corresponding to each of the coordinate positions on the chromaticity diagram, individually represent the features of different colors on the reaction surface. Therefore, even if the reaction surface suffers color irregularities, the above data are capable of indicating the features of the individual colors on the reaction surface.

Consequently, even if the reaction surface suffers color irregularities during the color reaction, the color of the reaction surface can be identified with high accuracy by checking the data used to identify the color of the reaction surface.

The arithmetic unit should preferably specify one piece of the reference data whose coordinates at a peak value of the frequencies most match those of the measured data, and should specify identifying information related to the specified piece of the reference data.

If the color that is developed on the reaction surface remains the same, the coordinates at a peak value of the frequencies do not vary even if the area of the color varies.

According to the present exemplary embodiment, furthermore, therefore, even if the area ratios of the colors that are developed on the reaction surface during the color reaction vary, the color of the reaction surface can be identified with high accuracy without being adversely affected by the variations of the area ratios of the colors.

The arithmetic unit should preferably calculate products of the frequencies at the same coordinates of the measured data and each piece of the reference data, add the products, and specify the identifying information which is related to the piece of the reference data whose sum is the greatest.

According to the present exemplary embodiment, furthermore, it is possible to specify, by way of calculation, one piece of the reference data whose co-ordinates at a peak value of the frequencies most match those of the measured data.

The storage should preferably store a plurality of sets of pieces of reference brightness information generated from the R, G, B signals of RGB bitmap data of a reaction surface which has caused a color reaction with a gas, in association with each of the pieces of the reference data and identifying information. The arithmetic unit should preferably generate measured brightness information from RGB bitmap images generated by the image capturing unit, and if there are a plurality of pieces of reference data corresponding to the measured data, then the arithmetic unit should preferably specify one piece of the reference brightness information which corresponds to the measured brightness information by checking each of the pieces of the reference brightness information related to the plural pieces of the reference data against the measured brightness information, and specify the identifying information which is related to the specified piece of the reference brightness information.

Brightness information generated from RGB bitmap images of the reaction surface varies depending on the concentration of the gas which has caused a color reaction with the reaction surface.

Therefore, the color of the reaction surface can be identified highly accurately based on the concentration of the gas.

If there are a plurality of pieces of the reference data corresponding to the measured data, then the arithmetic unit should preferably calculate errors between the measured brightness information and each of the pieces of the reference brightness information related to the plural pieces of the reference data, specify one piece of the reference brightness information, whose error is the smallest, as one piece of the reference brightness information corresponding to the measured brightness information, and specify identifying information which is related to the specified piece of the reference brightness information.

According to the present exemplary embodiment, the piece of the reference brightness information corresponding to the measured brightness information can be specified by way of calculation.

The storage should preferably store, as reference data and reference brightness information, measured data and measured brightness information that are generated by the arithmetic unit from RGB bitmap images that are captured in advance by the image capturing unit of the reaction surfaces which have caused color reactions with gases.

According to the present exemplary embodiment, the reference data and the reference brightness information represent information that depends on the characteristics of the image capturing unit, making it easy to match the reference data and the reference brightness information, and the image capturing characteristics of the image capturing unit.

The storage should preferably hold, as the reference data, measured data generated by the image capturing unit from RGB bitmap images that are captured in advance by the image capturing unit of the reaction surfaces which have caused color reactions with gases.

According to the present exemplary embodiment, the reference data represent information that depends on the characteristics of the image capturing unit, making it easy to match the reference data and the image capturing characteristics of the image capturing unit.

The identifying information should preferably represent information for identifying a gas which has chemically reacted with the reaction surface.

According to the present exemplary embodiment, it is thus possible to output identifying information for identifying a gas which has chemically reacted with the reaction surface. Therefore, it is easy to specify the gas which has chemically reacted with the reaction surface.

An exemplary advantage according to the present invention is that the color of the reaction surface can be identified with high accuracy even if the reaction surface suffers color irregularities during the color reaction.

While an exemplary embodiment of the present invention has been described using specific terms, such description is for illustrative purposes only, and it is to be understood that changes and variations may be made without departing from the spirit or scope of the following claims.

What is claimed is:

1. A color identifying apparatus for identifying a color of a reaction surface which has caused a color reaction with a gas to be specified, comprising:
a storage that, for every set of a plurality of referential color coordinates generated pixel by pixel from RGB bitmap images of a reaction surface which has caused a color reaction with a gas, stores pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface;
an image capturing unit that captures an image of the reaction surface and generates RGB bitmap images of the reaction surface;
an arithmetic unit that generates a plurality of measured color coordinates pixel by pixel from the RGB bitmap images generated by said image capturing unit, generates measured data, which represents both each coordinate on the chromaticity diagram and frequencies that depend on the numbers of the measured color coordinates corresponding to each one of the coordinates on the chromaticity diagram, specifies one piece of the reference data which corresponds to said measured data by checking the measured data against each piece of the reference data, and specifies the identification information which is related to said identified piece of the reference data; and
an output unit that outputs the identification information specified by said arithmetic unit.

2. The color identifying apparatus according to claim 1, wherein said arithmetic unit specifies one piece of the reference data whose coordinates at a peak value of the frequencies most match those of said measured data, and specifies the identification information which is related to said identified piece of the reference data.

3. The color identifying apparatus according to claim 2, wherein said arithmetic unit calculates products of the frequencies at the same coordinates of the measured data and each piece of the reference data, adds the products, and specifies the identification information which is related to the piece of the reference data whose sum is the greatest.

4. The color identifying apparatus according to claim 1, wherein said storage stores a plurality of sets of pieces of reference brightness information generated from the RGB bitmap images of the reaction surface which has caused the color reaction with the gas, in association with each of the pieces of the reference data and the identification information; and
said arithmetic unit generates measured brightness information from the RGB bitmap images generated by said image capturing unit, and if there are a plurality of pieces of reference data corresponding to the measured data, said arithmetic unit specifies one piece of the reference brightness information which corresponds to the measured brightness information by checking each of the pieces of the reference brightness information related to the plurality of pieces of the reference data against the measured brightness information, and specifies the identification information which is related to the specified piece of the reference brightness information.

5. The color identifying apparatus according to claim 4, wherein if there are a plurality of pieces of the reference data corresponding to the measured data, said arithmetic unit calculates errors between each of the pieces of the reference brightness information related to the plurality of pieces of the reference data and the measured brightness information, specifies one piece of the reference brightness information, whose error is the smallest, as one piece of the reference brightness information which corresponds to the measured brightness information, and specifies the identification information which is related to the specified piece of the reference brightness information.

6. The color identifying apparatus according to claim 4, wherein said storage stores, as said reference data and said reference brightness information, measured data and measured brightness information that are generated by said arithmetic unit from the RGB bitmap images that are captured in advance by said image capturing unit of reaction surfaces which have caused color reactions with gases.

7. The color identifying apparatus according to claim 1, wherein said storage stores, as said reference data, measured data that are generated by said arithmetic unit from the RGB bitmap images that are captured in advance by said image capturing unit of reaction surfaces which have caused color reactions with gases.

8. The color identifying apparatus according to claim 1, wherein said identification information comprises information for identifying the gas which has chemically reacted with the reaction surface.

9. A color identifying apparatus for identifying a color of a reaction surface which has caused a color reaction with a gas to be specified, comprising:
storage means, for every set of a plurality of referential color coordinates generated pixel by pixel from RGB bitmap images of a reaction surface which has caused a color reaction with a gas, for storing pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface;
image capturing means for capturing an image of the reaction surface and generating RGB bitmap images of the reaction surface;
arithmetic means for generating a plurality of measured color coordinates pixel by pixel from the RGB bitmap images generated by said image capturing means, generating measured data, which represents both each coordinate on the chromaticity diagram and frequencies that depend on the numbers of the measured color coordinates corresponding to each one of the coordinates on the chromaticity diagram, specifying one piece of the reference data which corresponds to said measured data by checking the measured data against each piece of the reference data, and specifying the identification information which is related to said identified piece of the reference data; and
output means for outputting the identification information specified by said arithmetic means.

10. A color identifying method adapted to be carried out by a color identifying apparatus including a storage, for identifying the color of a reaction surface which has caused a color reaction with a gas to be specified, comprising:
storing, in said storage, for every set of a plurality of referential color coordinates generated pixel by pixel from RGB bitmap images of a reaction surface which has caused a color reaction with a gas, pieces of reference data, which respectively represent both each coordinate on a chromaticity diagram and frequencies that depend on the numbers of the referential color coordinates corresponding to each one of the coordinates on the chromaticity diagram, and identification information for identifying the reaction surface;
generating RGB bitmap images of the reaction surface by capturing an image of the reaction surface;
generating a plurality of measured color coordinates pixel by pixel from the RGB bitmap images;
generating measured data which represents both each coordinate on the chromaticity diagram and frequencies that depend on the numbers of the measured color coordinates corresponding to each one of the coordinates on the chromaticity diagram;
specifying one piece of the reference data which corresponds to said measured data by checking the measured data against each piece of the reference data;
specifying the identification information which is related to said identified piece of the reference data; and
outputting the specified identification information.

11. The color identifying method according to claim 10, wherein said specifying one piece of the reference data comprises specifying the one piece of the reference data whose coordinates at a peak value of the frequencies most match those of said measured data.

12. The color identifying method according to claim 10, wherein said specifying one piece of the reference data comprises calculating products of the frequencies at the same coordinates of the measured data and each piece of the reference data, adding the products, and specifying the identification information which is related to the piece of the reference data whose sum is the greatest.

13. The color identifying method according to claim 10, wherein said storing comprises storing a plurality of sets of pieces of reference brightness information generated from the RGB bitmap images of the reaction surface which has caused the color reaction with the gas, in association with each of the pieces of the reference data and the identification information;
said color identifying method further comprising generating measured brightness information from the generated RGB bitmap images; and
wherein if there are a plurality of pieces of reference data corresponding to the measured data, said specifying the identification information comprises specifying one piece of the reference brightness information which corresponds to the measured brightness information by checking each of the pieces of the reference brightness information related to the plurality of pieces of the reference data against the measured brightness information, and specifying the identification information which is related to the specified piece of the reference brightness information.

14. The color identifying method according to claim 13, wherein said specifying the identification information comprises, if there are a plurality of pieces of reference data corresponding to the measured data, calculating errors between the measured brightness information and each of the pieces of the reference brightness information related to the plurality of pieces of the reference data, specifying one piece of the reference brightness information, whose error is the smallest, as one piece of the reference brightness information which corresponds to the measured brightness information, and specifying the identification information which is related to the specified piece of the reference brightness information.

15. The color identifying method according to claim 13, wherein said storing comprises storing, as said reference data and as said reference brightness information, measured data and measured brightness information that are generated by said color identifying apparatus in advance.

16. The color identifying method according to claim 10, wherein said storing comprises storing, as said reference data, measured data that are generated by said color identifying apparatus in advance.

17. The color identifying method according to claim 10, wherein said identification information comprises information for identifying the gas which has chemically reacted with the reaction surface.
